(19) United States
(12) Patent Application Publication
(10) Pub. No.: US 2019/0019640 A1
(43) Pub. Date: Jan. 17, 2019

(54) Self cleaning Rocking Electrical Contact Device for Semiconductor contacts

(71) Applicant: Jose E. Lopez, Sunnyvale, CA (US)

(72) Inventor: Jose E. Lopez, Sunnyvale, CA (US)

(73) Assignee: Jose E. Lopzed, Sunnyvale, CA (US)

(21) Appl. No.: 16/035,303

(22) Filed: Jul. 13, 2018

Related U.S. Application Data
(60) Provisional application No. 62/533,164, filed on Jul. 17, 2017.

(51) Int. Cl. H01H 23/12; H01H 1/18

(52) U.S. Cl. CPC H01H 23/12; H01H 1/18

(57) ABSTRACT

An electrical contact device has a housing with a vertical cavity and a horizontal cavity. A first contact element with a base that fits into the bottom of the vertical cavity of the housing, having a vertical primary protrusion from the end of the base, and having another vertical secondary protrusion from the other end of the base. The end of the secondary protrusion has a tertiary horizontal protrusion. The second contact element fits into the vertical cavity of the housing. The end of second contact element has a nub that inserts into a matching indentation under the tertiary protrusion of the first contact element, and acts as a retention feature. The other end of the second element is a vertical primary protrusion making contact with a device. A compliant element is positioned within the horizontal cavity of the housing and bracketed by the first contact element.

### CROSS REFERENCE TO RELATED APPLICATIONS

The present application claims the benefit of priority to the U.S. provisional patent application of the same title, having application Ser. No. 62/533,164, that was filed on Jul. 17, 2017, which is incorporated herein by reference.

### FIELD

The present invention relates to a test fixture for integrated circuit. The general use is to provide a connection between the leads of a semiconductor device and the conductive terminals of a printed circuit load board so as to allow an electrical tester to send electrical signals, measure the electrical response and therefore analyze the internal circuitry of the semiconductor device.

### BACKGROUND OF THE INVENTION

The objective of this invention is to propose a technique of contacting that maintains a reliable electrical contact between the leads of a semiconductor device under test (DUT) to the terminals of a printed circuit board (PCB) or load board so that the resistance is maintained low, prevents debris from entering the internal contact surfaces, minimal upward housing bow and no abrasion of the load board.

Two of the primary techniques for providing semiconductor contacts are utilizing two contact elements biased by an elastomeric element or by spring. In the elastomeric element technique, the contact elements are generally pegs with flanges on the opposite ends inserted in a common cavity of the elastomeric element. An issue arises for those skilled in the arts in that the improper biasing of the contact elements may cause a loss of bias between the contact elements and thereby cause an open contact or high contact resistance in the electrical path through the two contact elements.

Using a spring is another common technique of bias between the two contact elements for those skilled in the arts in the semiconductor testing industry. The contact elements are generally cylindrical bars with end flanges outwardly biased, and a spring between them. The spring and the two contact element's end flanges are generally enclosed within a conductive tube with narrowed ends to contain the end flanges and spring components, and allow the contact elements to slide along the tube. The problem is usually the electrical contact between the contact element that contacts the leads of the semiconductor device under test and the proximate narrowed end of the tube. After multiple actuations of this contact element, the clearance between the contact element and the narrowed end of the tube increases due to wear and the resulting gap reduces the contact reliability, along with debris entering, causing unstable resistance, opens and even jams for those skilled in the arts.

Still another technique for contacting used for those skilled in the arts within the semiconductor testing industry is a contact element is suspended between two elastomeric elements. The rolling of the contact element onto the load board minimizes contact pad wear but any slight slippage on the load board pad surface could still create wear due to the contact element's abrasion to the load board. Yet another concern would be debris entering in-between the contact element and the load board and embed itself due to the rolling action of the contact element. An additional concern would be the upward bulge of the two elastomeric elements during device actuation causing upward housing bow and compromising the contact element's bias to the load board.

### SUMMARY OF THE INVENTION

The invention consists of housing with a first surface that is usually placed into engagement with the surface of a load board. The housing has a second surface that is generally parallel to and spaced from the housing's first surface. The second surface is opposite facing the first surface. The housing has at least one slot that extends from the first to the second surface of the housing. In addition, the housing has a channel that extends crosswise from generally the middle of the slot and with a depth generally two-thirds of the depth of the slot with the opening facing the first surface.

A compliant element usually a uniform rod, typically with a generally square or rectangular cross section is positioned within the channel of the housing.

A first contact element made of conductive material with a base that fits into the slot mostly forming the bottom of the slot, proximate the first surface. The first contact element having a primary protrusion from the end of the base proximate the device leads and extends upward generally one-third of the depth of the slot hole. Additionally, the first contact element has a secondary protrusion from the other end of the base and extends upward generally equal the depth of the slot hole. Additionally, the end of the secondary protrusion has a tertiary protrusion that extends generally halfway along the length of the slot hole proximate the housing's second surface.

There is a second contact element made of conductive material with a member that fits into the slot proximate the second surface extending to mostly the length of the slot, and positioned underneath the tertiary protrusion of the first contact element. The end of second contact element that is proximate the first contact element's secondary protrusion has a primary protrusion that inserts into a matching indentation under the tertiary protrusion of the first contact element, so as to act as a retention feature for the second contact element.

The first contact element has a contact surface facing away from the second contact element's contact surface. Additionally, the first contact element's contact surface is generally composed of the surface of its base that faces the load board. This contact surface could be flat or composed of one or more nubs generally along the length of the base typically making contact with a least one trace on the load board.

The second contact element's contact surface is generally composed of the surface of its member that faces the device leads. This contact surface usually makes contact with the device leads and could be flat or composed of at least nub proximate the end which is away from the first contact element's secondary protrusion.

When the first contact element is engaged with a generally firm immovable surface, the second contact element responds to an inward force applied to its contact surface by moving inward, sliding forward, and deflecting the compliant element's surface. When this inward force is removed, the return of the compliant element to its original shape urges the second contact element back to its approximate initial position.

An important feature of the invention is the self-cleaning translational scrub of the contact surface on the device lead so that there is reliable contact and low and stable contact resistance even with intermittent debris or contamination. Another important feature is the position of the second contact elements' primary protrusion so that the contact surfaces between the first and second contact elements are covered from debris. Still another important feature is that the inward force upon the second contact element results in the compression of the compliant element which directly urges the first contact element to make contact to the load board, thereby generally making it unnecessary for the housing to excessively pre-load the compliant element to ensure the first contact element makes contact to the load board. In addition, the first contact element's primary and secondary protrusions are generally biased against the vertical walls of the compliant element so there is no horizontal translation and therefore no load board trace wear.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above recited and other advantages and objects are obtained, a more particular description of the embodiments will be rendered, which are illustrated in the accompanying drawings. These drawings depict only typical embodiments and are not therefore to be considered limiting of its scope.

FIG. 1 illustrates a preferred embodiment of the invention with two contact elements and a compliant rod within a half-sectioned housing.

FIG. 2 illustrates the first contact element.

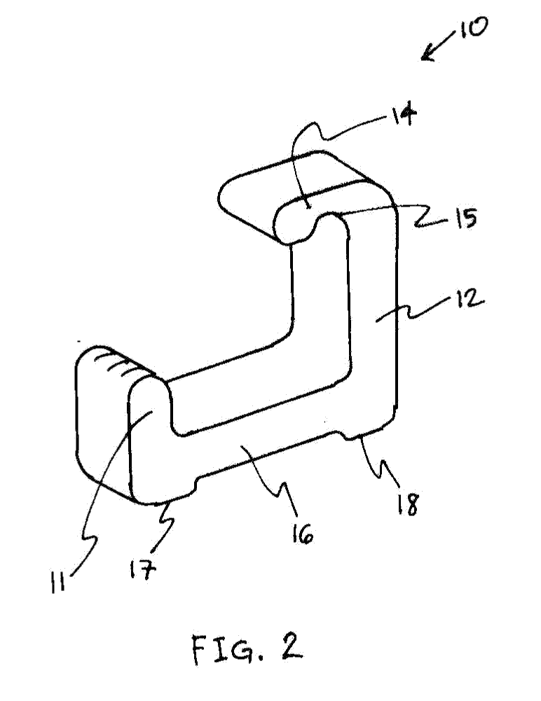

FIG. 3 illustrates the second contact element.

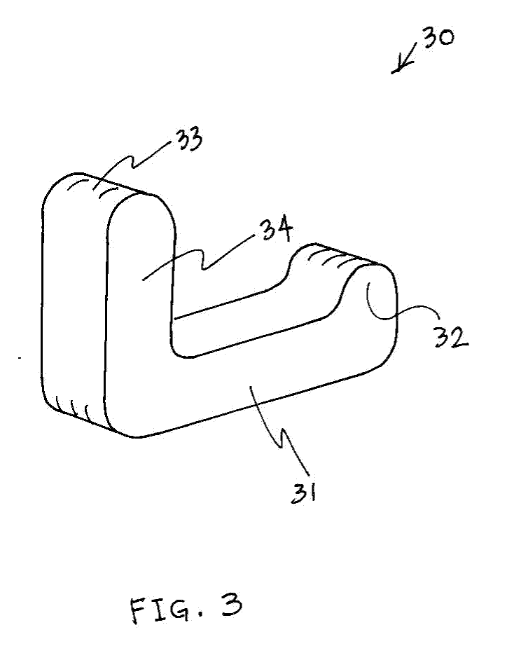

FIG. 4 illustrates the housing without the section cut.

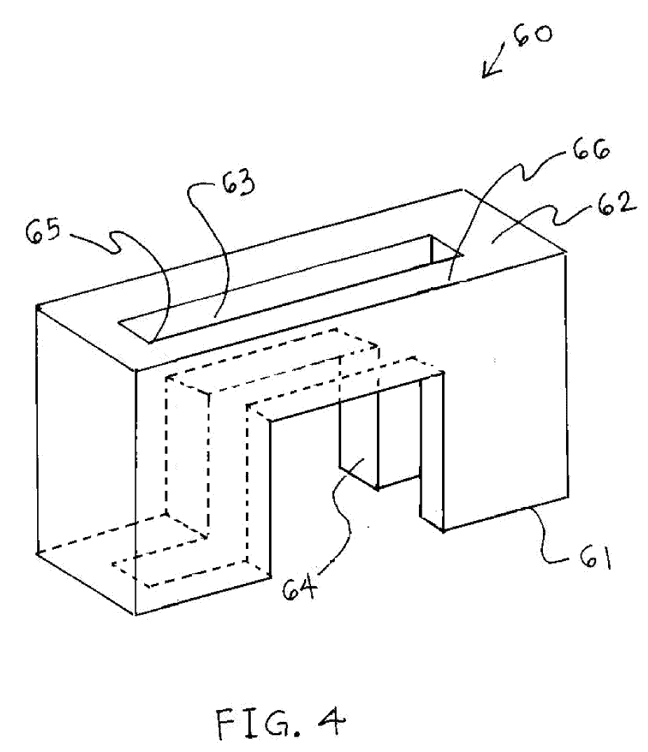

### DETAILED DESCRIPTION

Various embodiments are described hereinafter with reference to the figures. The figures are not drawn to scale and those elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment does not need to have all the aspects or advantages shown. An aspect or an advantage described in conjunction with a particular embodiment is not necessarily limited to that embodiment and can be practiced in any other embodiments even if not so illustrated.

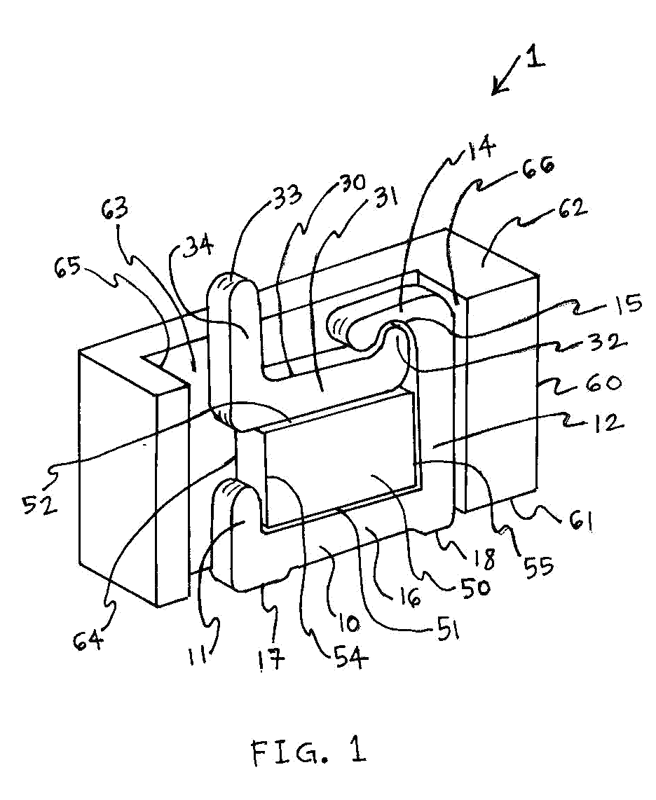

FIG. 1 illustrates the preferred embodiment of the electrical contact device 1, the housing 60 (or holder) is sectioned along the length of the slot 63 to show the internal components 30, 50, 10. The removed portion of the housing section is symmetrical to what is shown. FIG. 1 consists of an electrical connector 1 consisting of a housing 60 usually made of relatively insulative (dielectric) plastic or an equivalent material, which is typically positioned between the circuit traces of a load board (not shown) on the bottom and the device lead (not shown) on the top, with a slot 63 that extends through the thickness thereof from the first opposed surface 61 to the second opposed surface 62 of the housing 60, at the proximity of the circuit terminals of the load board and the device lead respectively. In addition, the housing has a channel 64 that crosses slot 63 and is usually a rectangle cut with a width approximately one-third the distance from the front slot end 65 to the rear slot end 66 and a depth approximately half the distance from the first surface 61 to the second surface 62 of the housing 60, with the opening facing the first surface 61 of the housing 60. The slot 63 and channel 64 can be manufactured by a milling machine process considering the resulting dimensional tolerances, manufacturing efficiencies and costs.

In addition, there is a first contact element 10, generally made of copper or other conductive material machined to an approximate G-shape from a flat plate. The first contact element 10 fits into the slot 63, forming a base 16 at the bottom of the slot of the housing 60, proximate the first surface 61. The first contact element's base metal piece 16 can extend from the left inner surface 65 of the housing 60 to the right inner surface 66 of the housing. In another embodiment, there is some space between first contact element 10 and the left inner surface 66 of the housing so that an operator can easily slide the first contact element into the slot in the housing. The height of the base metal piece 16 is approximately one eighth (⅛) the height of the housing 60. The first contact element having a primary protrusion 11 from the front end of the base metal piece 16 and extends upward, 90 degrees in orientation to the base metal piece and generally one-third of the depth of the slot hole 63, which is also one-third the distance from the primary 61 to the secondary surface 62. Additionally, the first contact element has a secondary protrusion 12 from the other rear end of the base 16 and extends upward generally equal the depth of the slot hole 63, which is also the distance from the primary 61 to the secondary surface 62. The secondary protrusion is 90 degrees in orientation to the base 16. Additionally, the end of the secondary protrusion 12 has a tertiary protrusion 14 that extends generally one quarter (¼) along the length of the slot hole 63, which is generally one quarter (¼) the distance from the front slot end 65 to the rear slot end 66. At the end of the tertiary protrusion is a round head 14 with an upward notch 15 between the round head and the connection of the tertiary protrusion with the secondary protrusion.

The first contact element 10 can have one or more contact surface(s) such as 17, 18 facing away from the second contact element's 30 contact surface 33. Additionally, the first contact element's 10 contact surface 17, 18 are generally composed of the surface of its base 16 that faces the load board. These contact surfaces could be flat generally along the length of the base 16 typically making contact with a least one trace on the load board.

Furthermore, there is a second contact element 30, generally made of copper or other conductive material machined to an approximate L-shape from a flat plate. The second contact element 30 fits into the top of the slot 63 in the housing 60, mostly forming a member 31 at the top of the slot 63, proximate the second surface 62 and positioned underneath the tertiary protrusion 14 of the first contact element. The end of the second contact element 30 has a primary protrusion 32 proximate the first contact element's 10 secondary protrusion 12 and extends from this end of the member 31 into a generally matching indentation 15 under the tertiary protrusion 14 of the first contact element 10, this serves as a retention feature for the second contact element 30. In an alternate embodiment, it is also possible for features 32, 15 to be reversed wherein the proximate end of the second contact element 30 will have the indentation and receive a generally matching protrusion under the tertiary protrusion 14 of the first contact element 10.

The second contact element's 30 contact surface 33 is generally comprised of the surface of its member 31 that faces the device leads. This contact surface could be flat or comprised of at least one nub 34 that makes contact with the device leads. The protrusion distance of this nub 34 is usually comprised of the distance required to extend above the secondary surface 62 and the distance desired to compress the compliant element 50 which will be described further.

Furthermore, there is a compliant element 50 usually an insulative rod, that could be made of rubber or silicone, typically with a square or rectangular cross section that is positioned within the channel 64 of the housing 60. The compliant element 50 is typically longer than the individual widths of the first 10 and second contact 30 to ensure there is adequate support of both contact elements 10, 30. The compliant element 50 has a first surface 51 proximate the first surface 61 of the housing 60 and engages the first contact element 10. Additionally, the compliant element 50 has a second surface 52 proximate the second surface 62 of the housing 60 and engages the second contact element 30.

The length of the housing slot 63 is longer than the length of the first 10 and second 30 contact element's base and member 16, 31 respectively and the width of the housing slot 63 is wider than the thickness of the first 10 and second 30 contact elements to allow the contact elements to generally fit inside the slot 63 and move freely. In addition, the front end wall 65 of the housing slot 63 proximate the second contact element 30 should be spaced so that the second contact element 30 does not conflict with the front end wall 65 of the slot 63 when second contact element 30 slides forward as actuated by an inward force.

The first contact 10 element has a base 16 that engages the first surface 51 of the compliant element 50 to ensure the first contact element's 10 contact surfaces 17, 18 engages the terminals of the load board. In addition, the first contact element 10 has primary and secondary protrusions 11, 12 respectively, generally at the ends of the base 16 to engage the proximate lateral surface 54, 55 of the compliant element 50 to act as retention and location feature for the first contact element 10 along the length of the slot 63. Consequently, it also locates the second contact element 30 due to the mutual link between the first contact element's 10 indentation 15 and the second contact element's primary protrusion 32.

The first contact element's 10 indentation 32 engages with the second contact element's 30 primary protrusion 32 to ensure electrical contact between the first 10 and second 30 contact element. These contact surfaces are internal and therefore less subject to debris contamination which could increase contact resistance. In addition, the second contact element 30 has a member 31 and a primary protrusion 32 that is positioned between the first contact element's 10 tertiary 14 protrusions and the compliant element's 50 second surface 52, these elements act as retention features for the second contact element 30.

With the first contact element's 10 contact surface 17; 18 engaged with a generally firm immovable surface (not shown), such as the terminals of a circuit load board, the second contact element 30 responds to an inward force applied to its contact surface 33 by deflecting the compliant element's 50 second surface 52 inward while the force is present. Generally, the more compliant element 50 volume is displaced the higher the force that is required to deflect it. In addition, because the second contact element 30 pivots generally on the rear between its primary protrusion 32 and the first contact element's 10 indentation 15, the second contact element's 30 contact surface 33 also moves forward along the device lead (not shown) which functions as a self-cleaning scrub of this contact surface 33. Generally, there has to be sufficient clearance between the second contact element's 30 protrusion 32 and the first contact element's 10 secondary protrusion 12 to allow the first contact element 10 to achieve the desired deflection of the compliant element's 50 second surface 52.

Once the inward force is removed the compliant element's 50 second surface 52 would urge the second contact element 30 in the opposite direction of the prior deflection and returns the second contact element 30 back to its general original position.

The height of the compliant element 50 should be spaced so that the proximate surface of both the first 10 and second 30 contact element's base 16 and member 31 respectively are generally parallel. In addition, the width of the compliant element 50 should be spaced so that it fits between the first contact element's 10 primary and secondary protrusions 11, 12 respectively. An increase in the compliant element's 50 durometer would cause an increase in the force per translation distance to actuate the second contact element 30 inward in a generally directly proportional relationship.

The contact surface 33 sliding along the device lead has the effect of preventing debris from adhering to the contact surface 33 and thereby maintaining low contact resistance for every subsequent device lead inserted. As a general rule the smaller the contact area and the longer the sliding distance along the device leads, the less contaminants will tend to accumulate onto the contact surface 33.

All examples and conditional language recited herein are intended for educational purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents hereof. Additionally, it is intended that such equivalents include both currently known equivalents as well as equivalents developed in the future, i.e., any elements developed that perform the same function, regardless of structure.

The invention claimed is:

1. An electrical contact device comprising of:
a rectangular dielectric housing having a vertical and cavity that extends from top to the bottom of said housing and extends from front to back;
said housing has a horizontal cavity which extends crosswise from said vertical cavity with the opening at the bottom surface of said housing;
a first contact element made of conductive material with a base that fits into said vertical cavity;
a base piece of said first contact element extending from front of said vertical cavity to the back of said vertical cavity;
a primary protrusion of said first contact element extending vertically from the base piece and extends partially up said vertical cavity;
a secondary protrusion of said first contact element attached at the other end of said base piece and extends vertically;
a tertiary protrusion of said first contact element attached to said secondary protrusion extending horizontally and partially along said vertical cavity of said housing;
a second contact element made of conductive material with a member that fits into said vertical cavity of said housing;
a base piece of said second contact element has a round nub as one end which is positioned underneath said tertiary protrusion of said first contact element,
a primary protrusion said second contact element attached to said base piece at the opposite end of said round nub that extends vertically outside top surface of said housing;
a compliant element made of insulative material which is positioned within said first contact element and below said second contact element;

2. The contact device of claim 1, wherein said tertiary protrusion of said first contact element has a round notch at the bottom of said tertiary protrusion such that said round nub of said second contact element fits into said round notch of tertiary protrusion.

3. The contact device of claim 2, wherein said compliant element width is wider than the vertical cavity of said housing and fills said crosswise horizontal cavity

4. The contact device of claim 2, wherein said second protrusion of said second contact element extends vertically to the top of said vertical cavity of said housing.

5. The contact device of claim 2, wherein said primary protrusion of said first contact element extends vertically less than half way up said compliant element such that the end of primary protrusion does not touch said second contact element.

6. The contact device of claim 2, wherein said tertiary protrusion is short enough so that the nub on said second contact element can be used to rotate said second contact element when device load is applied.

7. The contact device of claim 3, wherein said compliant element width fills completely within said base element, primary protrusion and secondary protrusion of said first contact element and below said second contact element.

8. The contact device of claim 3, wherein the first conductive contact element's base has at least one nub that extend outward and generally engages the traces of a load board.

9. The contact device of claim 3, wherein said second conductive element's member has at least one nub that extend vertically and engaging a device lead.

10. The contact device of claim 3, wherein the features are reversed and the end of said second contact element has an indentation that receives a generally matching protrusion under the tertiary protrusion of the first contact element.

11. The contact device of claim 3, wherein first contact element is made of copper.

12. The contact device of claim 3, wherein second contact element is made of copper.
